(19) United States
(12) Patent Application Publication
(10) Pub. No.: US 2025/0079525 A1
(43) Pub. Date: Mar. 6, 2025

(54) ELECTROLYTES FOR HIGH CAPACITY SILICON-BASED ANODE BATTERIES

(71) Applicant: Uchicago Argonne, LLC., Chicago, IL (US)

(72) Inventors: Zhengcheng Zhang, Naperville, IL (US); Eliot Woods, Evanston, IL (US); Dezhen Wu, Westmont, IL (US)

(73) Assignee: Uchicago Argonne, LLC., Chicago, IL (US)

(21) Appl. No.: 18/240,418

(22) Filed: Aug. 31, 2023

(51) Int. Cl. H01M 10/0569; H01M 10/052; H01M 10/0567

(52) U.S. Cl. CPC H01M 10/0569; H01M 10/052; H01M 10/0567

(57) ABSTRACT

An electrochemical cell includes an anode comprising silicon and an electrolyte comprising a linear carbonate and vinylene carbonate in a concentration of about 11 wt. % to about 80 wt. % based on the weight of the electrolyte. The electrolyte is free of saturated cyclic carbonates conventionally used in lithium-ion batteries.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to electrolytes for rechargeable electrochemical cells, and more specifically is related to electrolytes for silicon-based lithium-ion batteries.

### BACKGROUND

There is a demand for higher energy batteries for use in portable electronics and electric vehicles. Silicon (Si) anodes stand out among other candidate anode materials for its high theoretical specific capacity (4200 mAh/g for Li₁₅Si₄), safety (i.e. low or no flammability), and low cost. However, the high surface reactivity of commercial Si particles and the instability of lithiated silicon (LiₓSiy) with its surrounding environment presents challenges for its use in lithium-ion batteries. Attempts to stabilize the Si anode, such as surface functionalization or electrolyte additives, have provided only small improvements in battery performance.

### SUMMARY

In one aspect, an electrochemical cell includes an anode comprising silicon and an electrolyte. The electrolyte includes a solvent, a lithium salt, and a heterocyclic compound of formula:

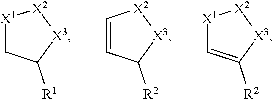

or a mixture of any two or more thereof. In the structures above, each X¹ independently is C or O; each X² independently is C═O or S(═O)₂; each X³ independently is C or O; each R¹ independently is linear alkenyl, linear alkenylalkyl, or linear acrylate; each R² independently is H, linear alkyl, linear alkenyl, linear alkenylalkyl, or linear acrylate; and either X² is S(═O)₂ or at least one of X¹ or X³ is O. The heterocyclic compound is present in the electrolyte at a concentration of about 11 wt. % to about 80 wt. % based on the weight of the electrolyte. The electrolyte is free of saturated cyclic carbonates.

In some embodiments, X¹ is O, X² is C═O, and X³ is O. In some embodiments, X² is S(═O)₂. In some embodiments, the heterocyclic compound is:

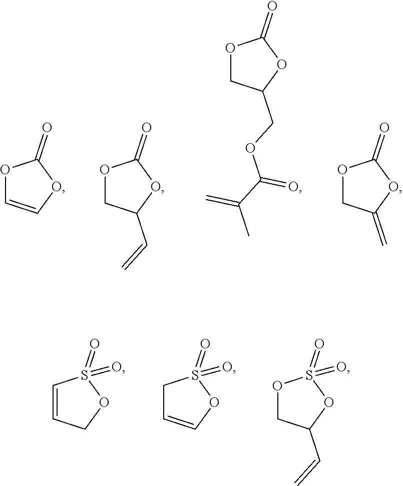

or a mixture of any two or more thereof. The heterocyclic compound may be vinylene carbonate.

In some embodiments, the electrolyte is free of fluoroethylene carbonate, difluoroethylene carbonate, and/or fluorinated propylene carbonate. The electrolyte may be free of saturated cyclic carbonates including ethylene carbonate and propylene carbonate.

In some embodiments, the heterocyclic compound may be present in the electrolyte from about 11 wt. % to about 20 wt. %. In some embodiments, the heterocyclic compound may be present in the electrolyte from about 30 wt. % to about 80 wt. %.

In some embodiments, the solvent may include a linear carbonate. The linear carbonate may include ethyl methyl carbonate, dimethyl carbonate, diethyl carbonate, or a mixture of any two or more thereof. In some embodiments, the solvent comprises 1,2-dimethoxyethane, 1,3-dioxolane, a fluorinated ether, a sulfone, or a mixture of any two or more thereof.

In some embodiments, the anode may include silicon in a concentration of about 50 wt. % to about 90 wt. %. The electrochemical cell may further include a solid electrolyte interface (SEI) comprising a hydroxylated polymer. The cathode may include a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof. The lithium salt may include LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10.

In another aspect, an electrochemical cell includes an anode including silicon and an electrolyte including a linear carbonate and vinylene carbonate in a concentration of about 11 wt. % to about 80 wt. %. The electrochemical cell is free of ethylene carbonate. In some embodiments, the electrolyte includes vinylene carbonate present in an amount of from about 15 wt. % to about 20 wt. %.

In another aspect, a method of screening the stability of an electrolyte component for lithium-silicon batteries includes contacting the electrolyte component with trimethylsilyllithium and identifying products of reactions between the electrolyte component and the trimethylsilyllithium.

### BRIEF DESCRIPTION OF THE DRAWINGS

FIG. 1 is a reaction scheme for the reaction of ethylene carbonate (EC) with trimethylsilyl lithium (Me₃SiLi).

FIG. 2A is a graph of ¹H NMR of concentrated crude reaction from Me₃SiLi and EC. The highlighted region indicates Me₃SiR peaks. Chain-ends have been drawn in a general format to reflect that EC polymerization may be initiated from either carbonyl or methylene attack.

FIG. 2B is a graph of ¹H NMR of polymer obtained from the scale-up reaction of Me₃SiLi and EC and authentic PEEC synthesized from EC and KOH for comparison.

FIGS. 3A to 3C show a reaction mechanism of EC polymerization with Me₃SiLi. FIG. 3A shows an anionic ring-opening polymerization initiated by nucleophilic attack of Me₃SiLi on EC. FIG. 3B shows PEEC undergoing chain scission at the carbonate repeat units via an elimination-base reaction. FIG. 3C shows chain scission of PEEC on lithiated silicon (LiₓSi_{y}), which releases PEO oligomers into the bulk electrolyte.

FIG. 4A is a reaction scheme of the degradation reaction of PEEC by Me₃SiLi.

FIG. 4B is a graph of gel permeation chromatography (GPC) traces of PEEC before reaction and the crude reaction solution after reaction with Me₃SiLi. The dashed line indicates the lower calibration limit of the GPC instrument at 370 g/mol polystyrene standard.

FIG. 5 is a reaction scheme of the reaction of fluoroethylene carbonate (FEC) with Me₃SiLi.

FIGS. 6A and 6B show a reaction mechanism of FEC conversion to vinylene carbonate (VC). FIG. 6A shows conversion of FEC to VC via reduction of the C—F bond followed by hydrogen atom abstraction. FIG. 6B shows the chemical reaction of FEC with nucleophilic silicon to produce VC via an elimination-base reaction.

FIG. 7A is a reaction scheme of Me₃SiLi and VC.

FIG. 7B is a graph of ¹H NMR of precipitated polymer from reaction of Me₃SiLi and VC.

FIG. 7C is a graph of ¹³C NMR of precipitated polymer from reaction of Me₃SiLi and VC.

FIG. 8A is a reaction scheme of Me₃SiLi and poly(VC).

FIG. 8B is a graph of MAS-NMR of poly(VC) (black), insoluble polymer obtained from reaction of poly(VC) and Me₃SiLi (red), and poly(hydroxymethylene) (blue). The peak labelled “*” is from residual DMF from the synthesis of poly(VC).

FIG. 9A is a graph of capacity retention of NMC811|Si cells with EC-based electrolyte (GenF: 1.2 M LiPF₆ EC/EMC (3:7 w/w)+3% FEC) and EC-free electrolytes 1.2 M LiPF₆ in EMC with 2 wt. %, 5 wt %, or 10 wt. % VC.

FIG. 9B is a graph of Coulombic efficiency of the NMC811|Si cells in FIG. 9A.

FIG. 10A is a graph of capacity retention of NMC811|Si cells with EC-based electrolyte (GenF: 1.2 M LiPF₆ EC/EMC (3:7 w/w)+3% FEC) and EC-free electrolytes 1.2 M LiPF₆ EMC/VC (10:1 w/w and 10:2 w/w) and 1.2 M LiPF₆ EMC/FEC (10:1 w/w and 10:2 w/w).

FIG. 10B is a graph of Coulombic efficiency of the NMC811|Si cells in FIG. 10A.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

### Definitions

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an organic group as defined below (e.g., an alkyl group) in which one or more bonds to a hydrogen atom contained therein are replaced by a bond to non-hydrogen and/or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SF₅), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

The term “alkyl,” by itself or as part of another substituent, means, unless otherwise stated, a saturated monovalent hydrocarbon radical, having, in some embodiments, one to eight (e.g., C₁-C₈ alkyl), or one to six (e.g., C₁-C₆ alkyl), or one to three carbon atoms (e.g., C₁-C₃ alkyl), respectively. The term “alkyl” encompasses straight and branched-chain hydrocarbon groups. Examples of alkyl groups include, but are not limited to, methyl, ethyl, n-propyl, isopropyl, n-butyl, t-butyl, isobutyl, sec-butyl, isopentyl, tert-pentyl, n-pentyl, isohexyl, n-hexyl, n-heptyl, 4-isopropylheptane, n-octyl, and the like. In some embodiments, the alkyl groups are C₁-C₃ alkyl groups (e.g., methyl, ethyl, or isopropyl).

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Representative substituted alkenyl groups may be mono-substituted or substituted more than once, such as, but not limited to, mono-, di- or tri-substituted with substituents such as those listed above.

The term “alkylene” refers to a straight or branched, saturated, hydrocarbon radical having, in some embodiments, one to six (e.g., C₁-C₆ alkylene), or one to four (e.g., C₁-C₄ alkylene), or one to three (e.g., C₁-C₃ alkylene), or one to two (e.g., C₁-C₂ alkylene) carbon atoms, and linking at least two other groups, i.e., a divalent hydrocarbon radical. When two moieties are linked to the alkylene they can be linked to the same carbon atom (i.e., geminal), or different carbon atoms of the alkylene group. For instance, a straight chain alkylene can be the bivalent radical of —(CH₂)ₙ—, where n is 1, 2, 3, 4, 5 or 6 (i.e., a C₁-C₆ alkylene). Representative alkylene groups include, but are not limited to, methylene, ethylene, propylene, isopropylene, butylene, isobutylene, secbutylene, pentylene, hexylene and the like. In some embodiments, the alkylene groups are C₁-C₃ alkylene groups (e.g., methylene, ethylene, or propylene).

As used herein, the term “alkoxy” refers to an alkyl group, as defined herein, that is attached to the remainder of the molecule via an oxygen atom (e.g., —O—C₁-C₁₂ alkyl, —O—C₁-C₈ alkyl, —O—C₁-C₆ alkyl, or —O—C₁-C₃ alkyl). Non-limiting examples of alkoxy groups include methoxy, ethoxy, n-propoxy, iso-propoxy, n-butoxy, sec-butoxy, n-pentoxy, n-hexoxy, and the like. In some embodiments, the alkoxy groups are C₁-C₆ alkoxy groups (e.g., methoxy, ethoxy, n-propoxy, iso-propoxy, butoxy, pentoxy, or hexyloxy).

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others.

Aryl groups are cyclic aromatic hydrocarbons that do not contain heteroatoms. Aryl groups herein include monocyclic, bicyclic and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

The term “cycloalkyl” refers to a monocyclic, bicyclic or polycyclic hydrocarbon ring system having, in some embodiments, 3 to 14 carbon atoms (e.g., C₃-C₁₄ cycloalkyl), or 3 to 10 carbon atoms (e.g., C₃-C₁₀ cycloalkyl), or 3 to 8 carbon atoms (e.g., C₃-C₈ cycloalkyl), or 3 to 6 carbon atoms (e.g., C₃-C₆ cycloalkyl) or 5 to 6 carbon atoms (e.g., C₅-C₆ cycloalkyl). Cycloalkyl groups can be saturated or characterized by one or more points of unsaturation (i.e., carbon-carbon double and/or triple bonds), provided that the points of unsaturation do not result in an aromatic system. Examples of monocyclic cycloalkyl groups include, but are not limited to, cyclopropyl, cyclobutyl, cyclopentyl, cyclohexyl, cyclohexeneyl, cyclohexynyl, cycloheptyl, cyclohepteneyl, cycloheptadieneyl, cyclooctyl, cycloocteneyl, cyclooctadieneyl, and the like. The rings of bicyclic and polycyclic cycloalkyl groups can be fused, bridged, or spirocyclic. Non-limiting examples of bicyclic, spirocyclic and polycyclic hydrocarbon groups include bicyclo[2.2.1]heptane, bicyclo[2.2.2]octane, adamantyl, indanyl, spiro[5.5]undecane, spiro[2.2]pentane, spiro[2.2]pentadiene, spiro[2.5]octane, spiro[2.2]pentadiene, and the like. In some embodiments, the cycloalkyl groups of the present disclosure are monocyclic C₃-C₇ cycloalkyl moieties (e.g., cyclopropyl, cyclobutyl, cyclopentyl, cyclohexyl, or cycloheptyl).

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups.” Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

The terms “alkyloyl” and “alkyloyloxy” as used herein can refer, respectively, to —C(O)-alkyl groups and —O—C(O)-alkyl groups. Similarly, “aryloyl” and “aryloyloxy” refer to —C(O)-aryl groups and —O—C(O)-aryl groups.

The term “carboxylate” as used herein refers to a —COOH group.

The term “ester” as used herein refers to —COOR⁷⁰ and —C(O)O-G groups. R⁷⁰ is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T. W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR⁷¹R⁷², and —NR⁷¹C(O)R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C(O)—(C₁₋₅ alkyl) and the group is termed “carbonylamino,” and in others the amide is —NHC(O)-alkyl and the group is termed “alkanoylamino.”

The term “nitrile” or “cyano” as used herein refers to the —CN group.

Urethane groups include N- and O-urethane groups, i.e., —NR⁷³C(O)OR⁷⁴ and —OC(O)NR⁷³R⁷⁴ groups, respectively. R⁷³ and R⁷⁴ are independently a substituted or unsubstituted alkyl, alkenyl, alkynyl, cycloalkyl, aryl, aralkyl, heterocyclylalkyl, or heterocyclyl group as defined herein. R⁷³ may also be H.

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “sulfonamido” includes S- and N-sulfonamide groups, i.e., —SO₂NR⁷⁸R⁷⁹ and —NR⁷⁸SO₂R⁷⁹ groups, respectively. R⁷⁸ and R⁷⁹ are independently hydrogen, or a substituted or unsubstituted alkyl, alkenyl, alkynyl, cycloalkyl, aryl, aralkyl, heterocyclylalkyl, or heterocyclyl group as defined herein. Sulfonamido groups therefore include but are not limited to sulfamoyl groups (—SO₂NH₂). In some embodiments herein, the sulfonamido is —NHSO₂-alkyl and is referred to as the “alkylsulfonylamino” group.

The term “thiol” refers to —SH groups, while “sulfides” include —SR⁸⁰ groups, “sulfoxides” include —S(O)R⁸¹ groups, “sulfones” include —SO₂R⁸² groups, “sulfonyls” include —SO₂OR⁸³, and “sulfonates” include —SO₃. R⁸⁰, R⁸¹, R⁸², and R⁸³ are each independently a substituted or unsubstituted alkyl, cycloalkyl, alkenyl, alkynyl, aryl aralkyl, heterocyclyl or heterocyclylalkyl group as defined herein. In some embodiments the sulfide is an alkylthio group, —S-alkyl.

The term “urea” refers to —NR⁸⁴—C(O)—NR⁸⁵R⁸⁶ groups. R⁸⁴, R⁸⁵, and R⁸⁶ groups are independently hydrogen, or a substituted or unsubstituted alkyl, alkenyl, alkynyl, cycloalkyl, aryl, aralkyl, heterocyclyl, or heterocyclylalkyl group as defined herein.

The term “amidine” refers to —C(NR⁸⁷)NR⁸⁸R⁸⁹ and —NR⁸⁷C(NR⁸⁸)R⁸⁹, wherein R⁸⁷, R⁸⁸, and R⁸⁹ are each independently hydrogen, or a substituted or unsubstituted alkyl, cycloalkyl, alkenyl, alkynyl, aryl aralkyl, heterocyclyl or heterocyclylalkyl group as defined herein.

The term “guanidine” refers to —NR⁹⁰C(NR⁹¹)NR⁹²R⁹³, wherein R⁹⁰, R⁹¹, R⁹² and R⁹³ are each independently hydrogen, or a substituted or unsubstituted alkyl, cycloalkyl, alkenyl, alkynyl, aryl aralkyl, heterocyclyl or heterocyclylalkyl group as defined herein.

The term “enamine” refers to —C(R⁹⁴)═C(R⁹⁵)NR⁹⁶R⁹⁷ and —NR⁹⁴C(R⁹⁵)═C(R⁹⁶)R⁹⁷, wherein R⁹⁴, R⁹⁵, R⁹⁶ and R⁹⁷ are each independently hydrogen, a substituted or unsubstituted alkyl, cycloalkyl, alkenyl, alkynyl, aryl aralkyl, heterocyclyl or heterocyclylalkyl group as defined herein.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O⁻. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “imine” refers to —CR¹⁰⁰(NR¹⁰¹) and —N(CR¹⁰⁰R¹⁰¹) groups, wherein R¹⁰⁰ and R¹⁰¹ are each independently hydrogen or a substituted or unsubstituted alkyl, cycloalkyl, alkenyl, alkynyl, aryl aralkyl, heterocyclyl or heterocyclylalkyl group as defined herein, with the proviso that R¹⁰⁰ and R¹⁰¹ are not both simultaneously hydrogen.

The term “nitro” as used herein refers to an —NO₂ group.

The term “trifluoromethyl” as used herein refers to —CF₃.

The term “trifluoromethoxy” as used herein refers to —OCF₃.

The term “azido” refers to —N₃.

The term “trialkyl ammonium” refers to a —N(alkyl)₃ group. A trialkylammonium group is positively charged and thus typically has an associated anion, such as halogen anion.

The term “isocyano” refers to —NC.

The term “isothiocyano” refers to —NCS.

The term “pentafluorosulfanyl” refers to —SF₅.

This disclosure also contemplates isomers of the compounds described herein (e.g., stereoisomers, and atropisomers). For example, certain compounds of the present disclosure possess asymmetric carbon atoms (chiral centers), or hindered rotation about a single bond; the racemates, diastereomers, enantiomers, and atropisomers (e.g., Ra, Sa, P, and M isomers) of which are all intended to be encompassed within the scope of the present disclosure. Stereoisomeric forms may be defined, in terms of absolute stereochemistry, as (R) or (S), and/or depicted uses dashes and/or wedges. When a stereochemical depiction (e.g., using dashes, [symbol] , and/or wedges, [symbol] ) is shown in a chemical structure, or a stereochemical assignment (e.g., using (R) and (S) notation) is made in a chemical name, it is meant to indicate that the depicted isomer is present and substantially free of one or more other isomer(s) (e.g., enantiomers and diastereomers, when present). “Substantially free of” other isomer(s) indicates at least an 70/30 ratio of the indicated isomer to the other isomer(s), more preferably 80/20, 90/10, or 95/5 or more. In some embodiments, the indicated isomer will be present in an amount of at least 99%. A chemical bond to an asymmetric carbon that is depicted as a solid line ( [symbol] ) indicates that all possible stereoisomers (e.g., enantiomers, diastereomers, racemic mixtures, etc.) at that carbon atom are included. In such instances, the compound may be present as a racemic mixture, scalemic mixture, or a mixture of diastereomers.

### Overview

Disclosed herein are non-aqueous electrolytes for electrochemical cells including silicon-based anodes that may improve electrochemical cycling performance, electrochemical cells including these non-aqueous electrolytes, and methods of making and using the same.

The chemical mechanisms that produce the solid-electrolyte-interphase (SEI) on silicon (Si) anodes has remained largely speculative and contradictory. A common hypothesis for the origin of failure for silicon anode batteries is the inability of conventional carbonate electrolytes (typically mixtures of cyclic EC and a linear carbonate) to effectively passivate the surface of the silicon electrode. Previous research has attempted to understand the poor passivation of carbonates on silicon by studying the composition of the SEI. Despite this research, the mechanism underlying the formation of the silicon SEI has remained unknown.

It has now been observed that chemical mechanisms of electrolyte degradation on lithiated silicon interfaces that lead to failure of silicon anode batteries may involve saturated cyclic carbonates. Saturated cyclic carbonates may react with silicon anodes to form solvent-soluble products, which do not appreciably contribute to the formation of a stable SEI. Saturated cyclic carbonates are common components of conventional electrolytes and include, for example, cyclic EC and propylene carbonate (PC). Thus, according to various embodiments herein, the non-aqueous electrolytes may exclude saturated cyclic carbonates such as EC and/or PC.

Without being bound by any theory, silicon nucleophiles at the surface of lithiated silicon anodes may initiate ring-opening polymerization of saturated cyclic carbonates to form poly(ethylene ether carbonate) (PEEC). PEEC was found to be unstable to silicon nucleophiles, degrading to highly soluble polyethylene oxide (PEO) oligomers that do not provide surface passivation on silicon.

It has now also been observed that unsaturated cyclic carbonates may react with silicon anodes to form products that may form stable SEIs on silicon anodes. Thus, according to various embodiments herein, the non-aqueous electrolytes may include unsaturated cyclic carbonates, such as vinylene carbonate.

Without being bound by any theory, silicon nucleophiles at the surface of lithiated silicon anodes may initiate ring-opening polymerization of unsaturated cyclic carbonates to form polyhydroxyalkylenes, which may be chemically robust and insoluble in conventional electrolyte solvents. These stable and insoluble polymers may provide stable surface passivation on silicon.

### Non-Aqueous Electrolytes

In one aspect, non-aqueous electrolytes are provided that exclude saturated cyclic carbonates. These electrolytes may provide stable electrochemical cycling to electrochemical cells with Si anodes.

The unsaturated cyclic carbonates may contain a solvent and a salt dissolved therein. The solvent excludes saturated cyclic carbonates. For example, the solvent may exclude EC and/or PC. In some embodiments, the solvent may also exclude fluorinated carbonates, such as fluoroethylene carbonate, difluoroethylene carbonate, and fluorinated propylene carbonate.

Illustrative solvents include, but are not limited to, linear carbonates, 1,2-dimethoxyethane (DME), 1,3-dioxolane (DOL), fluorinated ethers, sulfones, or a mixture of any two or more thereof. For example, the solvent may include one or more of ethyl methyl carbonate (EMC), dimethyl carbonate (DMC), diethyl carbonate (DEC), DME, DOL, 2,2-dimethoxy-4-(trifluoromethyl)-1,3-dioxolane (DTDL), ethyl methyl sulfone (EMS), or tetramethyl sulfone (TMS).

The salt dissolved in the solvent may be a lithium salt. Illustrative lithium salts include, but are not limited to LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10. The salt may be present in the electrolyte at any amount including from about 0.5 M to 3 M. This may include from about 1 M to about 2M.

The electrolyte also includes one or more heterocyclic compounds represented as Formulas I-III:

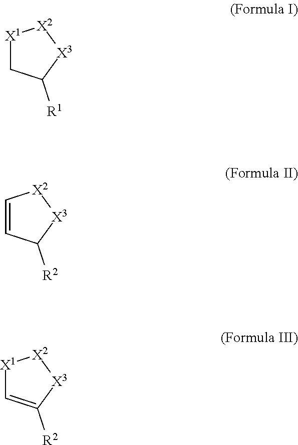

or a mixture of any two or more thereof. In the above Formulas I-III, each X¹ independently is C or O; each X² independently is C═O or S(═O)₂; each X³ independently is C or O; each R¹ independently is linear alkenyl, linear alkenylalkyl, or linear acrylate; each R² independently is H, linear alkyl, linear alkenyl, linear alkenylalkyl, or linear acrylate; and either X² is S(═O)₂ or at least one of X¹ or X³ is O. In some embodiments, the heterocycle is a carbonate where X¹ is O, X² is C═O, and X³ is O. In some embodiments, the heterocycle is an organosulfur compound where X² is S(═O)₂. Examples of heterocyclic compounds represented by Formulas I-III include, but are not limited to,

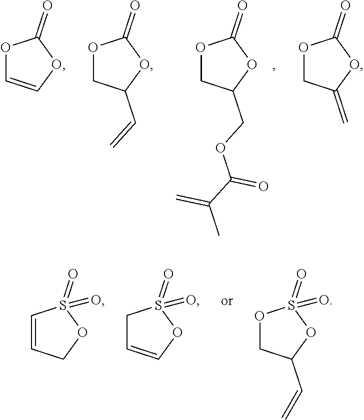

In some embodiments, the heterocyclic compound represented by Formulas I-III includes vinylene carbonate.

The heterocyclic compound represented by Formulas I-III is present in the electrolyte at a concentration of about 11 wt. % to about 80 wt. % based on the weight of the electrolyte. In some embodiments, the heterocyclic compound is present in amount of about 11 wt. % to about 20 wt. % (e.g., 11 wt. %, 12 wt. %, 13 wt. %, 14 wt. %, 15 wt. %, 16 wt. %, 17 wt. %, 18 wt. %, 19 wt. %, or 20 wt. %). In some embodiments, the heterocyclic compound is present in amount of about 15 wt. % to about 20 wt. %. In some embodiments, the heterocyclic compound is present in amount of about 30 wt. % to about 80 wt. % (e.g., 30 wt. %, 35 wt. %, 40 wt. %, 45 wt. %, 50 wt. %, 55 wt. %, 60 wt. %, 65 wt. %, 70 wt. %, 75 wt. %, or 80 wt. %).

### Electrochemical Cells

In another aspect, a secondary electrochemical cell includes a cathode, an anode, and any of the non-aqueous electrolytes described herein. The secondary electrochemical cell may be a lithium-ion battery. The non-aqueous electrolyte includes heterocyclic compounds represented by Formulas I-III and excludes saturated cyclic carbonates, such as ethylene carbonate. The anode includes an anode active material including silicon, and may also include a binder. The cathode may include a cathode active material and a binder. The secondary electrochemical cells may further include a separator between the cathode and the anode. The secondary electrochemical cells may further include current collectors for one or all electrodes.

The anode active material may include silicon nanoparticles, silicon microparticles, silicon macroparticles, bulk silicon, or mixtures of any two or more thereof. The anode may comprise the silicon in a concentration of about 10 wt. % to about 100 wt. % or about 50 wt. % to about 90 wt. % (e.g., 50 wt. %, 55 wt. %, 60 wt. %, 65 wt. %, 70 wt. %, 75 wt. %, 80 wt. %, 85 wt. %, or 90 wt. %). The anode may further include lithium metal and/or another conductive material (e.g., carbonaceous material). The carbonaceous material may include natural graphite, synthetic graphite, hard carbon, amorphous carbon, soft carbon, mesocarbon microbeads (MCMB), acetylene black, Ketjen black, carbon black, mesoporous carbon, porous carbon matrix, carbon nanotube, carbon nanofiber, and graphene.

The cathode active material may be any of a wide variety of lithium-containing cathode active materials including lithium nickel-manganese-cobalt oxide compositions, and the like. In some embodiments, the cathode active material includes, but is not limited to a spinel, olivine, Li_{1+W}MnₓNi_{y}Co_{z}O₂, LiMn_{x′}Ni_{y′}O₄, or a′Li₂MnO₃·(1−a′)LiMO₂, wherein 0<w<1, 0≤x<1, 0≤y<1, 0≤z<1, and x+y+z=1; 0≤x′<2, 0≤y′<2, and x′+y′=2; and 0≤a′<2. As used herein, a “spinel” refers to a manganese-based spinel such as, Li₁₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5. The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0. Other cathode active materials may include any of the following, alone or in combination with any of the cathode active materials described herein, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″≤3; with the proviso that at least one of h, k and 1 is greater than 0. In any embodiment, the cathode active material may include a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.

The cathode active material may also be accompanied by a conductive carbon material such as natural graphite, synthetic graphite, hard carbon, amorphous carbon, soft carbon, mesocarbon microbeads (MCMB), acetylene black, Ketjen black, carbon black, mesoporous carbon, porous carbon matrix, carbon nanotube, carbon nanofiber, and graphene.

Illustrative binder materials for the cathode and/or anode include, but are not limited to polyvinylidene fluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), a copolymer of any two or more such polymers, and a blend of any two or more such polymers.

Illustrative separator materials include, but are not limited to, a microporous or modified polymer separator. Illustrative separators include, but are not limited to, Celgard® 2325, Celgard® 2400, Celgard® 3501, and glass fiber separators.

In some embodiments, the secondary electrochemical cell includes an SEI disposed at the anode. The SEI may be formed upon contacting the silicon anode with the non-aqueous electrolyte and/or may be formed upon electrochemically cycling the electrochemical cell. The SEI may include a hydroxylated polymer that is insoluble in the electrolyte. They hydroxylated polymer may be a highly hydroxylated polymer, such as poly(hydroxymethylene) (“poly(HM)”). The hydroxylated polymer may be a product of the decomposition of an electrolyte component, such as the heterocyclic compound represented by Formulas I-III.

### Methods of Screening

In a further aspect, a method of screening the stability of electrolyte components for electrochemical cells including silicon is disclosed. The electrochemical cell may be a lithium-ion battery with a silicon anode. The method includes contacting the electrolyte component with trimethylsilyllithium such that a reaction occurs and products are formed. Products of the reaction are identified by characterization according to the understanding in the art.

The present invention, thus generally described, will be understood more readily by reference to the following examples, which are provided by way of illustration and are not intended to be limiting of the present invention.

### EXAMPLES

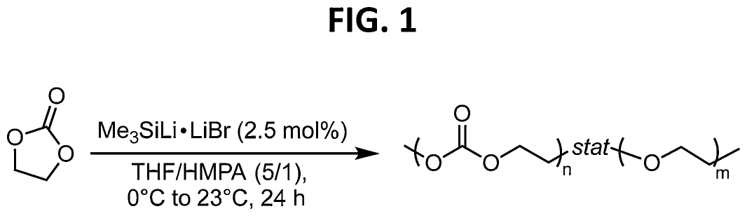

As shown in FIG. 1, trimethylsilyl lithium (Me₃SiLi), a silicon nucleophile, was used to study the chemical mechanisms of electrolyte failure on lithiated silicon interfaces. Me₃SiLi is a readily prepared, potent nucleophile that reacts with a variety of electrophiles. Me₃SiLi is a solution phase reagent that reacts solely as an ionic nucleophile, thereby providing detailed structure analysis of electrolyte degradation products and rationalization of the chemical mechanisms that produced them. The Me₃SiLi system was used to demonstrate that silicon nucleophiles can initiate the ring-opening polymerization of EC to form poly(ethylene ether carbonate) (PEEC). PEEC may be unstable to silicon nucleophiles, degrading to highly soluble PEO oligomers, which do not provide surface passivation on silicon. In contrast to EC, FEC reacted with Me₃SiLi to form poly(hydroxymethylene), a chemically robust and insoluble polymer, thereby providing stable surface passivation on silicon. The findings from this mechanism study led to the new EC-free, VC-based electrolyte that showed significantly improved electrochemical performance over traditional electrolytes, as demonstrated in NMC811 Si batteries.

A model system compound, Me₃SiLi, was used to systematically study the chemical mechanisms of electrolyte reactivity on lithiated silicon electrodes. This model system provided a platform to study electrolyte degradation specific to nucleophilic lithiated silicon, allowing for the rationalization of reaction mechanisms at the silicon interface. The inventors identified the polymer PEEC as the likely product of anionic ring-opening polymerization, as initiated by nucleophilic silyl anion attack on EC. PEEC may then undergo chain-scission at the carbonate repeat units via a base-elimination reaction with Me₃SiLi to generate oligomers of PEO, which is soluble in the electrolyte. In contrast, no evidence of a ring-opening reaction of FEC was observed with Me₃SiLi. Instead, FEC may have reacted with Me₃SiLi via a base-elimination reaction to form VC. The subsequent poly(VC) may then have reacted to form a highly insoluble and chemically robust polymer poly(HM), a resilient SEI component. By using these mechanistic insights, a new EC-free electrolyte was designed and validated in NMC811/Si cells, confirming that EC-free electrolytes outperformed traditional carbonate electrolytes and further demonstrating that EMC/VC cosolvent electrolytes provided superior cell performance, likely because of the formation of a polymeric-rich SEI for silicon surface passivation.

### Experimental Procedures

Unless otherwise noted, reactions were performed under an argon atmosphere in oven-dried (120° C.) glassware using the Schlenk technique. Organic solvents were removed in vacuo using a rotary evaporator (Buchi Rotovapor R-210, ˜20-200 torr) and residual solvent was removed under high vacuum (<0.1 torr).

Commercial reagents were purchased and used as received unless otherwise noted. THE used for reactions was distilled off calcium hydride under an argon atmosphere and degassed by 3 freeze-pump-thaw cycles before being stored on activated 3 Å molecular sieves. The hexamethylphosphoramide (HMPA) used for reactions was absolute, over molecular sieve (H₂O≤0.03%), ≥98.0% (GC) and was stored under an argon atmosphere. Ethylene carbonate and fluoroethylene carbonate were distilled under vacuum and stored on activated 3 Å molecular sieves in an argon atmosphere. The purity of vinylene carbonate impacts to its performance in cosolvent formulations. Vinylene carbonate used for electrolyte formulations was stirred over calcium hydride under argon for two hours, before being vacuum transferred into a storage flask and stored cold (2° C.) in an argon atmosphere.

Proton nuclear magnetic resonance (H NMR) spectra and carbon nuclear magnetic resonance (¹³C NMR) spectra were recorded at 300 MHz, 500 MHz, and 125 MHz and referenced to the solvent residual peaks.

¹H and ¹³C solid-state magic-angle-spinning (MAS) NMR measurements were performed at a Larmor frequency of 500.13 and 125.76 MHz, respectively. All the samples were pulverized and densely packed in 3.2-mm rotors. ¹H spectra were collected using single pulse at 20 kHz with a recycle delay of 10 s and referred to adamantine at 1.8 ppm. ¹H/¹³C Cross Polarization (CP) experiments were conducted to enhance ¹³C signal near ¹H at 10 kHz. A contact time of 4 ms and a pulse delay of 2 s were used. NMR data are represented as follows: chemical shift (δ ppm), multiplicity (s=singlet, d=doublet, t=triplet, q=quartet, m=multiplet), and coupling constant in Hertz (Hz), integration.

Size exclusion chromatography (SEC) measurements were performed in stabilized, HPLC-grade tetrahydrofuran with refractive index detectors, guard column (Agilent PLgel; 5 μm; 50×7.5 mm), and three analytical columns (Agilent PLgel; 5 μm; 300×7.5 mm; 105, 104, and 103 Å pore sizes). The instrument was calibrated with narrow dispersity polystyrene standards between 370 g/mol and 364,000 g/mol. All runs were performed at 1.0 mL/min flow rate and 40° C. Molecular weight values are calculated based on the refractive index signal.

Because of solubility limitations in THF, poly(vinylene carbonate) SEC was measured in N,N-dimethylacetamide with 50 mM LiCl at 50° C. and a flow rate of 1.0 mL/min (columns: Visco-gel I-series 5 μm guard+two ViscoGel I-series G3078 mixed bed columns, molecular weight range 0-20 and 0-10,000 kg/mol). Detection consisted of a refractive index detector operated at 658 nm and a light scattering detector operated at 690 nm. Absolute molecular weights and molecular weight distributions for the macro-CTAs were calculated using the Wyatt ASTRA software, and dn/dc values were obtained from 100% mass recovery methods. The molecular weights were determined against a calibration curve of poly(styrene) (PS) standards with molecular weights ranging from 1.3 kg/mol to 327 kg/mol.

Procedure for trimethylsilyl lithium reaction. In a Schlenk flask with a PTFE stir bar, THE (1 mL), HMPA (0.2 mL), and hexamethyldisilane (59 μL, 0.31 mmol) were charged under argon. The solution was cooled to 0° C. before a methyllithium lithium bromide complex in diethyl ether (177 μL, 1.5 M) was injected dropwise, causing the reaction solution to flush a deep orange color, indicating the formation of Me₃SiLi. This solution was stirred for 10 minutes.

For small-scale testing, if the electrolyte component that was reacted with Me₃SiLi was a liquid, the component was injected into the Me₃SiLi solution directly. If the component was polymeric and/or solid, the polymer and/or solid would be prepared in a separate flask under argon before the Me₃SiLi solution was transferred onto it. After combination of Me₃SiLi with the electrolyte component of interest, the reaction was allowed to continue for 24 hours before reaction sampling and analysis.

For larger scale testing, if the electrolyte component that was reacted with Me₃SiLi was a liquid, the Me₃SiLi was added to the electrolyte component liquid. For example, in a Schlenk flask with a PTFE stir bar, ethylene carbonate (16.4 g, 186 mmol) was charged under argon. The flask was heated to 40° C. to liquefy the ethylene carbonate before Me₃SiLi solution (53 mL, 82 mM) was prepared (as described above). After 24 hours the reaction was placed under a high vacuum and heated to 85° C. to remove unreacted monomer. The resulting reaction concentrate was passed through crosslinked polystyrene beads (Bio-Beads S—X1) to help remove remaining non-volatile small molecule impurities using THE as the eluent. Because of the highly polar nature of PEEC, complete removal of HMPA from the polymer sample was not possible. While HMPA remains in the sample, its signal at 2.65 ppm does not overlap with any peaks of interest from PEEC or SiMe₃ groups.

Electrode materials and cell assembly. CR-2032 coin cells were assembled in an argon-filled glovebox for cycling with a 15-mm-diameter Si anode, a 17-mm-diameter Celgard 2325 separator, 40 μL of electrolyte, and a 14-mm-diameter LiNi_{0.8}Mn_{0.1}Co_{0.1}O₂ (NMC 811) cathode. The “GenF” and “Gen 2” electrolytes consisted of 1.2 M LiPF₆ in EC/EMC (3:7, by weight) with and without, respectively, 3 wt. % FEC. Additionally, a series of test electrolytes were formulated consisting of 1.2 M LiPF₆ in EMC/VC (10:1 and 10:2, by weight) and 1.2 M LiPF₆ in EMC/FEC (10:1 and 10:2, by weight). The Si anode consisted of 80 wt. % milled Si, 10 wt. % C45 carbon, and 10 wt. % P84 Polyimide binder cast onto copper (Cu) foil at a total coating loading of 1.19 mg cm⁻² The NMC 811 cathode consisted of 90 wt. % NMC 811 (Targray), 5 wt. % C45, and 5 wt. % Solvay 5130 polyvinylidene fluoride (PVDF) cast onto an aluminum current collector at a total coating loading of 15.81 mg cm⁻². The excess loading on the NMC 811 cathode was specifically designed to avoid pre-lithiation to balance the capacity on the anode side of the cell for the cycling operation in the range of 3.2 V to 4.2 V.

Electrochemical testing. Cells were tested on a battery cycler at room temperature of 25° C. Cells were first exposed to two 1.5 V “tap charges” at a current of 0.1 C rate (with 1 C═3.0 mA). “Tap charges” allow for additional time for wetting and pin the anode at a lower potential to avoid copper corrosion as the cells wet. Cells were then cycled at 0.333 C rate, with upper and lower cut-off voltages of 4.2 V and 3.2 V, respectively. The cells were rested for 18 hours at 3.2 V before C/3 cycling resumed.

### Example 1: EC Reaction with Me₃SiLi

Lithiated silicon initiates the ring-opening polymerization of EC. EC has been identified as a critical component of state-of-the-art electrolytes for graphite anodes because of its strong solvation with Li⁺ and passivating SEI formation. However, for silicon anodes, EC is subject to nucleophilic attack by the lithiated silicon. To investigate the chemical reactivity of EC with lithiated silicon, trimethylsilyl lithium (Me₃SiLi) was prepared according to the procedure described above as a model compound for the chemical reactivity of lithiated silicon interface, as shown in FIG. 1. A 2.5 mol % ratio of Me₃SiLi to EC was used to minimize its overreaction with resulting organic products and allow for a “step-by-step” understanding of the reactivity.

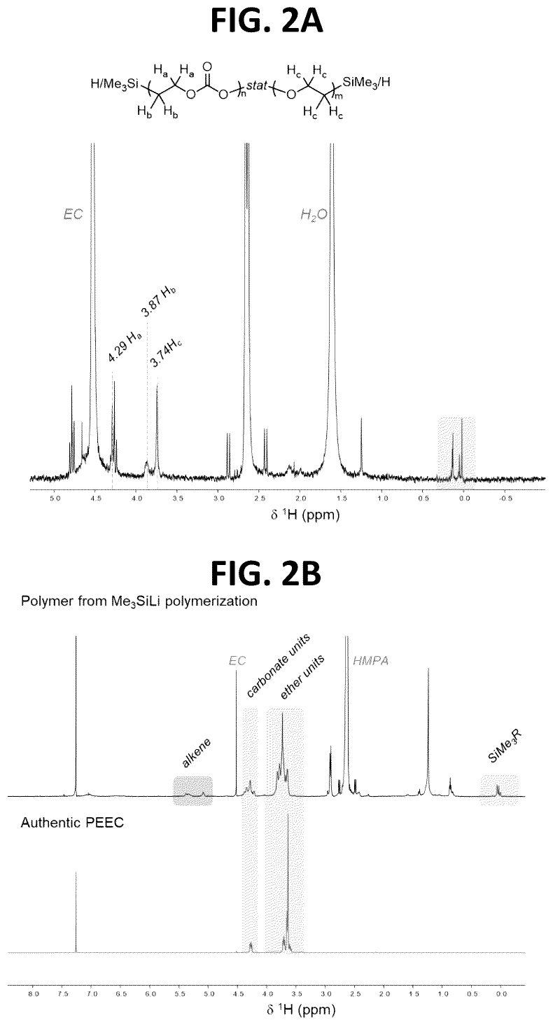

FIG. 2A is a graph of the ¹H NMR of the reaction product, after removal of THF, showing new peaks at 4.29 ppm, 3.86 ppm, and 3.74 ppm, consistent with PEEC, the product of the anionic ring-opening polymerization of EC. Additionally, peaks between 0.14 ppm and 0.02 ppm suggest new alkyl silane species, supporting the trimethylsilyl initiated polymerization of EC.

To study the connectivity of the trimethylsilyl groups to the observed PEEC, the polymerization was scaled up, and the polymer was isolated from the unreacted monomer and solvent via vacuum distillation and chromatography. FIG. 2B is a graph of the ¹H NMR of the obtained material from the scaled-up reaction. The obtained material showed broad carbonate (4.41-4.19 ppm) and ether units (3.89-3.61 ppm) consistent with PEEC, as well as alkyl silane signals between 0.07 ppm and 0.01 ppm, which suggest EC ring-opening polymerization. Additionally, there were peaks at 5.33 ppm and 5.07 ppm that may have originated from an intramolecular chain-scission reaction during the work-up of the polymer that led to alkene chain-ends. The GPC data of the polymer showed a multimodal molecular weight distribution of (1) 9.3 kg/mol and D: 2.89 and (2) 0.6 kg/mol and D: 1.31, supporting the assignment of chain-scission oligomers within the higher-molecular-weight polymer sample. To confirm the connectivity of the trimethylsilyl peaks in the ¹H NMR to PEEC polymer, the polymer was analyzed with ¹H DOSY. The PEEC carbonate and ether peaks at 4.32 ppm and 3.67 ppm and trimethylsilyl peaks at 0.05 ppm showed diffusion rates within error of each other, suggesting that they diffuse as a single molecular species.

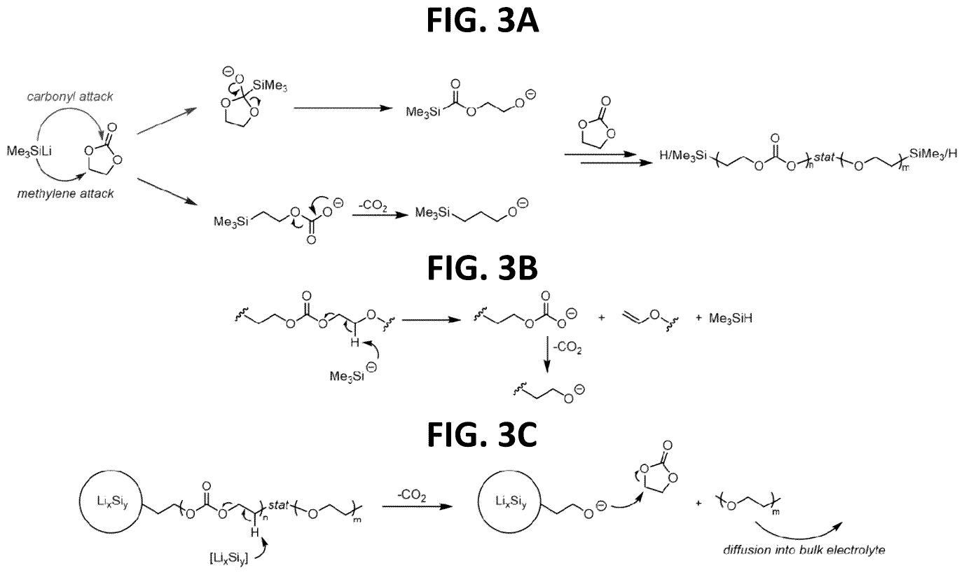

FIGS. 3A to 3C show a reaction mechanism of EC polymerization with Me₃SiLi. FIG. 3A shows an anionic ring-opening polymerization initiated by nucleophilic attack of Me₃SiLi on EC. FIG. 3B shows PEEC undergoing chain scission at the carbonate repeat units via an elimination-base reaction. FIG. 3C shows chain scission of PEEC on lithiated silicon (LiₓSi_{y}), which releases PEO oligomers into the bulk electrolyte. The PEEC obtained from the model reaction may be explained by an anionic ring-opening polymerization initiated by nucleophilic attack of Me₃SiLi on EC, as shown in FIG. 3A. Anionic silicon can attack EC at either the carbonyl carbon or methylene carbon. Either site of attack leads to the generation of an alkoxide that can then further react with additional EC to propagate the polymerization generating the statistical copolymer PEEC. This mechanism has interesting implications for silicon anode batteries, as common electrolytes use EC with a range of lithium salt (e.g., about 1.0 M to 1.5 M lithium salt). Taken together, these results suggest that the lithiated silicon surface and high lithium salt concentration may act as a primed environment for the ring-opening polymerization of EC.

### Example 2: PEEC Degradation by Me₃SiLi

PEEC is degraded to PEO oligomers by Me₃SiLi silicon nucleophiles. With the silicon-initiated polymerization of PEEC identified in Example 1, the chemical stability of PEEC to lithiated silicon was investigated next. The poor capacity retention of EC/DMC (1:1 by volume) with 1 M LiPF₆ electrolyte suggests that this SEI may not effectively passivate the silicon electrode. As shown in the scheme in FIG. 3B, PEEC is highly unstable with bases, undergoing chain scission at the carbonate repeat units via an elimination-base reaction. Without being bound by any theory, the silicon nucleophiles may also be able to perform this elimination-base reaction, degrading the PEEC to oligomeric fragments that are soluble in the electrolyte, as shown in FIG. 3C. This may explain why an EC/DMC electrolyte alone cannot passivate a silicon electrode.

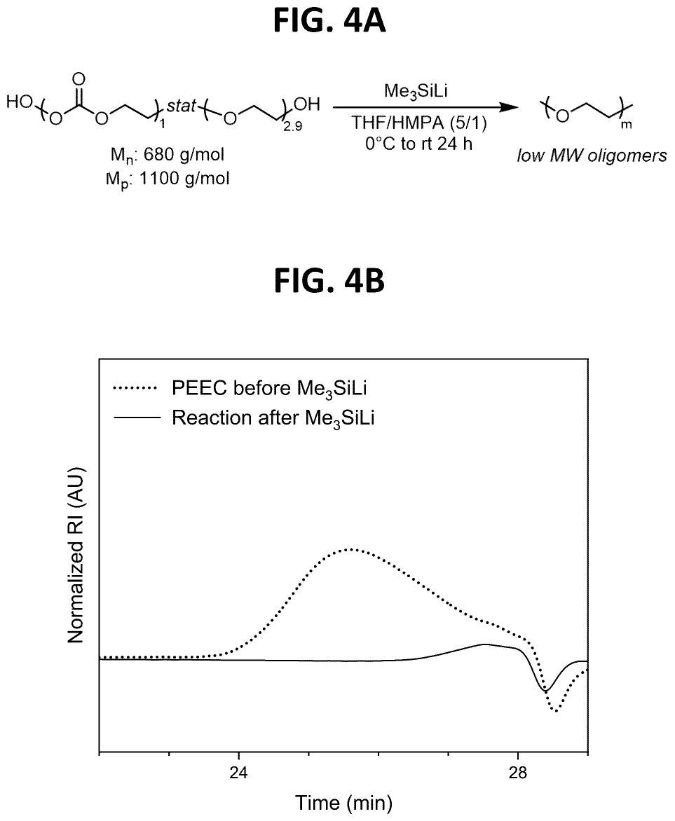

To investigate, an authentic sample of PEEC was synthesized (Mn: 680 g/mol, Ð: 2.03) and subjected to treatment with Me₃SiLi according to the reaction in FIG. 4A. FIG. 4B compares the GPC traces of the synthesized PEEC sample before reaction with Me₃SiLi and the crude reaction mixture of PEEC reacted with Me₃SiLi. The GPC traces indicated a complete loss of the PEEC polymer peak at 25.6 min. The ¹H NMR of the reaction mixture showed that the signal at 4.29 ppm from the carbonate repeat unit was completely gone and an overlapping set of peaks was seen between 3.71 ppm and 3.81 ppm, which may indicate the formation of a mixture of PEO oligomers. The GPC and ¹H NMR data together suggest that Me₃SiLi degrades PEEC through an elimination-base reaction at the carbonate units according to the scheme in FIG. 3B, yielding low-molecular-weight PEO oligomers.

This mechanism has implications for the stability of SEIs formed from EC-based electrolytes on silicon electrodes. The ability for lithiated silicon to initiate ring-opening polymerization of EC means that even small gaps in the SEI that expose lithium silicide to the electrolyte may consume large amounts of EC. Further, the chain-scission of PEEC by silicon anions makes it unlikely that PEEC can contribute any effective passivation to the SEI. Rather, after PEEC is formed it will likely undergo chain scission, releasing PEO oligomers into the bulk electrolyte and leaving an alkoxide on the SEI that can reinitiate polymerization of EC, according to the scheme in FIG. 3C.

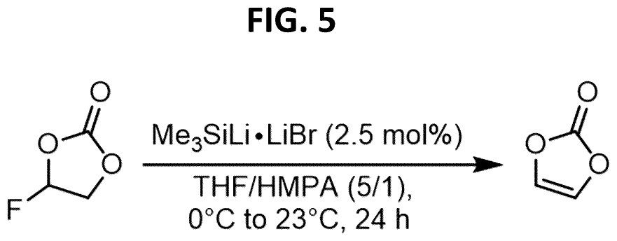

The terminal organic product of FEC with lithiated silicon is poly(hydroxymethylene). FEC as an electrolyte additive is known to impart large improvements in capacity retention and calendar life for silicon anode batteries. The mechanisms, however, for this improvement have remained uncertain. Given the similar cyclic carbonate structures of FEC and EC, it is curious as to how such different polymers could be formed on the same active material. To understand the difference in reactivity that could lead to different polymers in the silicon SEI, a Me₃SiLi model system was used to investigate FEC, as shown in FIG. 5.

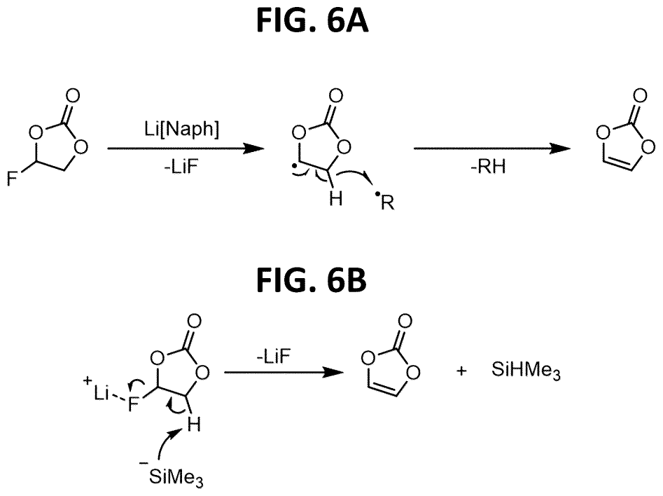

Unlike EC, the ¹H NMR of the reaction of FEC with Me₃SiLi showed no sign of a ring-opening polymerization product. Instead, the ¹H NMR indicated the appearance of vinylene carbonate (VC) at 7.13 ppm. The conversion of FEC to VC may be via reduction of the C—F bond followed by hydrogen atom abstraction, as shown in the scheme in FIG. 6A.

Alternatively or additionally, the mechanism of the chemical reaction of FEC with nucleophilic silicon to produce VC may also proceed via an elimination-base reaction, as shown in FIG. 6B. VC generation at the silicon anode may explain the observation of an enrichment of aliphatic polymers in the SEI. The divergence of reaction mechanisms of lithiated silicon with FEC and EC may suggest that VC may play a role in the passivation of silicon anodes.

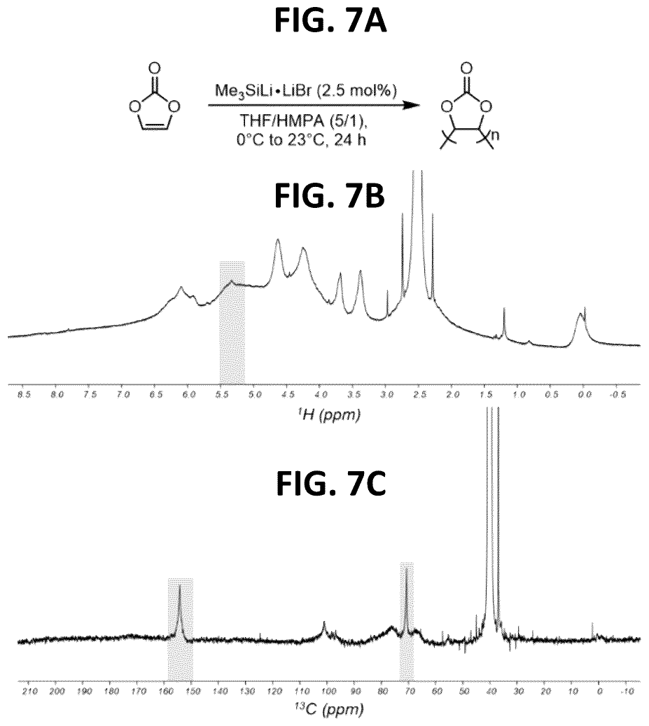

To further elucidate the downstream organic products of VC with lithiated silicon, VC was reacted with Me₃SiLi, as shown in FIG. 7A. The reaction of Me₃SiLi with VC produced poly(vinylene carbonate) (“poly(VC)”) as indicated by ¹H and ¹³C NMR shown in FIGS. 7B and 7C. The ¹³C peaks at 154.4 ppm and 70.7 ppm and matches the expected carbonyl and methylene carbons of poly(vinylene carbonate), with the corresponding peak in the ¹H spectrum at 5.34 ppm. The numerous other broad peaks beyond poly(VC) both in the ¹H and ¹³C spectrum may indicate there are other species within the polymer sample beyond poly(VC). ¹H DOSY analysis of the sample indicated that the poly(VC) signal at 5.34 ppm diffuses at the same rate within error of signals at 6.11 ppm, 4.64 ppm, 4.26 ppm, and 0.02 ppm in the sample. This result may suggest that poly(VC) continues to react and is not the final organic product of silicon nucleophiles with FEC.

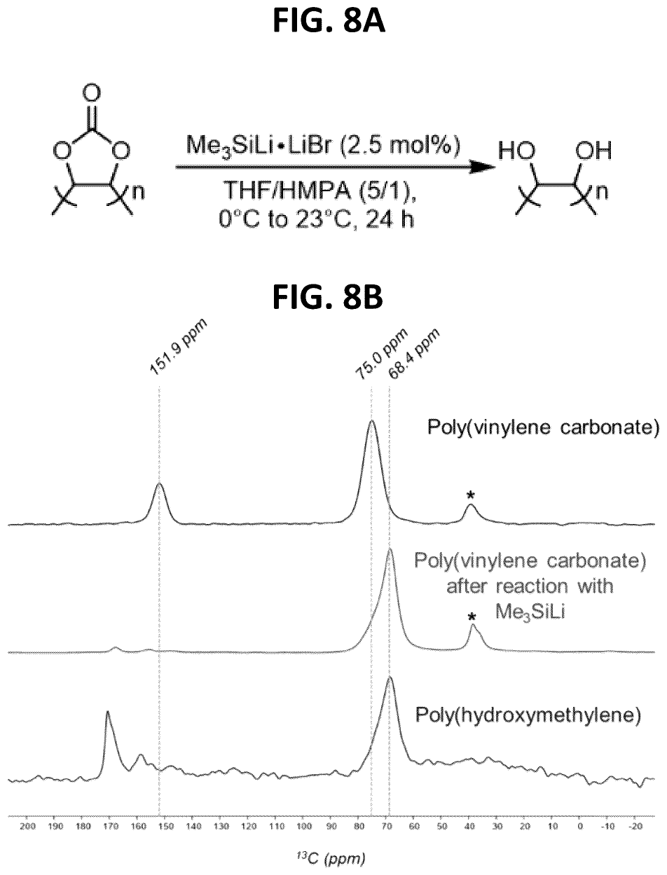

An authentic sample of poly(VC) was synthesized via radical polymerization (Mn: 89 kg/mol, D: 1.55) and reacted with Me₃SiLi, as shown in FIG. 8A. A completely insoluble material was obtained from the reaction. By using MAS-NMR, the ¹³C signals of the authentic poly(VC) sample were compared to the material obtained after the reaction, shown in FIG. 8B. After the reaction with Me₃SiLi, there was a loss of signal from the carbonyl carbon of poly(VC) at 151.9 ppm and a shift of the methylene carbon of the polymer backbone from 75 ppm to 68.4 ppm. The loss of the carbonyl carbon, but retention of the backbone methylene, may suggest the cyclic carbonate structure decomposed and an aliphatic polymer product persisted. The hydrolysis of the carbonate units may lead to a highly hydroxylated polymer-poly(hydroxymethylene) (“poly(HM)”), as shown in FIG. 8A. An authentic sample of poly(HM) was prepared via treatment of poly(VC) with 30% potassium hydroxide solution. Comparing the MAS-NMR ¹³C signals of the synthesized poly(HM) to the obtained insoluble product of poly(VC) and Me₃SiLi showed an alignment of the methylene carbon signals at 68.4 ppm, as shown in FIG. 8B. Further, the residual carbonyl signals in the samples between 172 ppm and 147 ppm showed a similar three-peak intensity pattern.

Poly(HM) may be the terminal organic product of FEC on silicon anodes. The production of poly(HM) may provide a rationale for the powerful passivating ability of FEC on silicon. Poly(HM) is completely insoluble in common organic solvents. Poly(HM) has excellent resistance to both acid and base corrosion and no electrophilic positions along the polymer backbone for chain-scission. These properties make poly(HM) a useful component to help passivate and stabilize the silicon/electrolyte SEI.

### Example 3: Battery Cycling with EC-Free Electrolytes

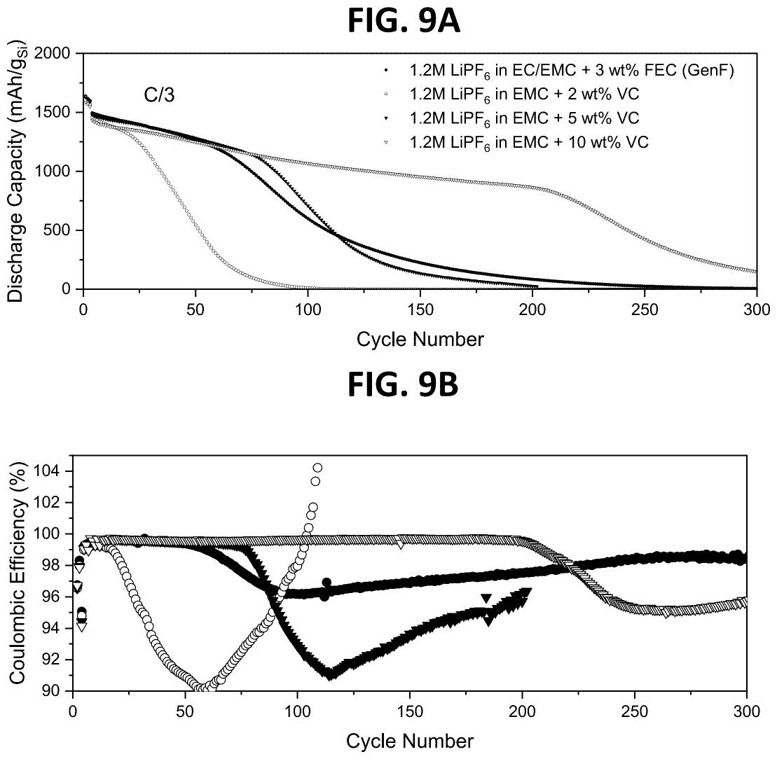

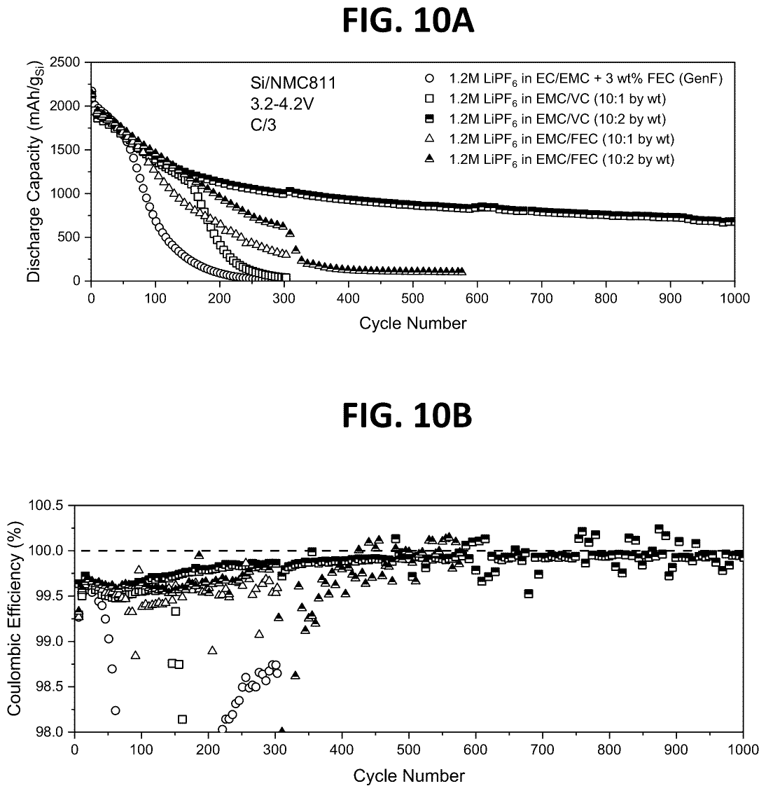

EC-free electrolyte outperforms GenF (Gen2+3% FEC). With an understanding that FEC may react to produce poly(HM) to stabilize the silicon SEI, the inventors appreciated that VC and FEC electrolytes may provide similar performance on silicon anodes. Previous studies comparing the effects of VC and FEC as electrolyte additives for silicon batteries have included EC in the electrolyte formulation, destabilizing the SEI and thus making a direct comparison of VC's and FEC's ability to passivate the silicon surface challenging. Here, electrolytes were formulated that were EC-free to avoid the deleterious EC polymerization of PEEC on the silicon anode. In place of EC, VC was used as an additive to serve as the dominant compound to form SEI. These EC-free electrolytes formulations were cycled in NMC811|Si full cells and compared to the widely used EC-based electrolyte GenF (Gen2+3% FEC: 1.2 M LiPF₆ EC/EMC 3:7 w/w+3 wt. % FEC). The cell performance of the NMC811/Si cell with EC-free electrolyte with VC additive (1.2 M LiPF₆ EMC+2%, 5% and 10% VC, respectively) are shown in FIGS. 9A and 9B. The results indicated that cells with EC-free electrolytes with higher concentrations of the VC additive improved both the cell capacity retention and Coulombic efficiency compared with the traditional GenF electrolyte. This result was born out over extensive charge/discharge cycling. To further manifest the impact of the EC-free electrolytes, new electrolyte formulations with VC as cosolvent (>10%) were prepared (1.2 M LiPF₆ EMC/VC with VC at 10:1 w/w and 10:2 w/w), and long-term cycling data of NMC811|Si cells are shown in FIGS. 10A and 10B. The EMC/VC (10:2 w/w) cell outperformed the GenF and EMC/VC (10:1 w/w) cell with significantly higher capacity retention (33% of initial capacity) at 950 cycles, indicating that a higher concentration of VC results in stable cycling. In contrast, a similar EC-free electrolyte using FEC as its cosolvent (1.2 M LiPF₆ EMC/FEC with FEC at 10:1 w/w and 10:2 w/w) showed much worse cell performance than the VC formulations.

The superior performance of the EC-free electrolyte with VC as additive and cosolvent over FEC may be related to the different reaction pathways identified in Example 2. Before the formation of poly(HM) as a robust SEI component on the silicon anode, FEC may react with lithiated silicon to generate VC and LiF as a side product, thereby consuming active lithium and leading to lower Coulombic efficiency and rapid capacity fade. The battery performance data agree with the predicted SEI stability from Examples 1 and 2.

### REFERENCES

Franco Gonzalez, A.; Yang, N.-H.; Liu, R.-S. J Phys Chem C 2017, 121, 27775-27787.
Zhang, C.; Wang, F.; Han, J.; Bai, S.; Tan, J.; Liu, J.; Li, F. Small Struct 2021, 2, 2100009.
Eshetu, G. G.; Zhang, H.; Judez, X.; Adenusi, H.; Armand, M.; Passerini, S.; Figgemeier, E. Nat Commun 2021, 12, 5459.
Zuo, X.; Zhu, J.; Müller-Buschbaum, P.; Cheng, Y.-J. Nano Energy 2017, 31, 113-143.
McBrayer, J. D.; Rodrigues, M.-T. F.; Schulze, M. C.; Abraham, D. P.; Apblett, C. A.; Bloom, I.; Carroll, G. M.; Colclasure, A. M.; Fang, C.; Harrison, K. L.; Liu, G.; Minteer, S. D.; Neale, N. R.; Veith, G. M.; Johnson, C. S.; Vaughey, J. T.; Burrell, A. K.; Cunningham, B. Nat Energy 2021, 6, 866-872.
Xu, Z.; Yang, J.; Li, H.; Nuli, Y.; Wang, J. J Mater Chem A Mater 2019, 7, 9432-9446.
Kim, J.; Chae, O. B.; Lucht, B. L. J Electrochem Soc 2021, 168, 030521.
Wang, A.; Kadam, S.; Li, H.; Shi, S.; Qi, Y. NPJ Comput Mater 2018, 4, 15.
Jin, Y.; Kneusels, N.-J. H.; Magusin, P. C. M. M.; Kim, G.; Castillo-Martinez, E.; Marbella, L. E.; Kerber, R. N.; Howe, D. J.; Paul, S.; Liu, T.; Grey, C. P. J Am Chem Soc 2017, 139, 14992-15004.
Jin, Y.; Kneusels, N.-J. H.; Marbella, L. E.; Castillo-Martinez, E.; Magusin, P. C. M. M.; Weatherup, R. S.; Jónsson, E.; Liu, T.; Paul, S.; Grey, C. P. J Am Chem Soc 2018, 140, 9854-9867.
Jin, Y.; Kneusels, N.-J. H.; Grey, C. P. J Phys Chem Lett 2019, 10, 6345-6350.
Asenbauer, J.; Eisenmann, T.; Kuenzel, M.; Kazzazi, A.; Chen, Z.; Bresser, D. Sustain Energy Fuels 2020, 4, 5387-5416.
Borodin, O.; Ren, X.; Vatamanu, J.; von Wald Cresce, A.; Knap, J.; Xu, K. Ace Chem Res 2017, 50, 2886-2894.
Xu, K. Chem Rev 2004, 104, 4303-4418.
Seitzinger, C. L.; Sacci, R. L.; Coyle, J. E.; Apblett, C. A.; Hays, K. A.; Armstrong, R. R.; Rogers, A. M.; Armstrong, B. L.; Bennet, T. H.; Neale, N. R.; Veith, G. M. Chem Mater 2020, 32, 3199-3210.
Coyle, J. E.; Brumbach, M. T.; Veith, G. M.; Apblett, C. A. J Phys Chem C 2020, 124, 8153-8161.
Han, B.; Zhang, Y.; Liao, C.; Trask, S. E.; Li, X.; Uppuluri, R.; Vaughey, J. T.; Key, B.; Dogan, F. ACS Appl Mater Interfaces 2021, 13, 28017-28026.
Gong, L.; Leung-Toung, R.; Tidwell, T. T. J Org Chem 1990, 55, 3634-3639.
Still, W. C. J Org Chem 1976, 41, 3063-3064.
Abdul-Karim, R.; Hameed, A.; Malik, M. I. RSC Adv 2017, 7, 11786-11795.
von Seggern, N.; Schindler, T.; Naumann, S. Biomacromolecules 2020, 21, 2661-2669.
Lee, J.-C.; Litt, M. H. Macromolecules 2000, 33, 1618-1627.
Gu, K.; Onorato, J.; Xiao, S. S.; Luscombe, C. K.; Loo, Y.-L. Chem Mater 2018, 30, 570-576.
Li, W.; Chung, H.; Daeffler, C.; Johnson, J. A.; Grubbs, R. H.
Macromolecules 2012, 45, 9595-9603.
Kapiti, G.; Keul, H.; Möller, M. Mater Today Commun 2015, 5, 1-9.
Zhang, S.; He, M.; Su, C.-C.; Zhang, Z. Curr Opin Chem Eng 2016, 13, 24-35.
Schroder, K.; Alvarado, J.; Yersak, T. A.; Li, J.; Dudney, N.; Webb, L. J.; Meng, Y. S.; Stevenson, K. J. Chem Mater 2015, 27, 5531-5542.
Etacheri, V.; Haik, O.; Goffer, Y.; Roberts, G. A.; Stefan, I. C.; Fasching, R.; Aurbach, D. Langmuir 2012, 28, 965-976.
Young, B. T.; Heskett, D. R.; Nguyen, C. C.; Nie, M.; Woicik, J. C.; Lucht, B. L. ACS Appl Mater Interfaces 2015, 7, 20004-20011.
Xu, C.; Lindgren, F.; Philippe, B.; Gorgoi, M.; Bjorefors, F.; Edström, K.; Gustafsson, T. Chem Mater 2015, 27, 2591-2599.
Michan A. L., Parimalam B. S., Leskes M., Kerber R. N., Yoon T., Grey C. P., and Lucht B. L. Chem Mater 2016 28, 8149-8159
Kumru, B.; Bicak, N. RSC Adv 2015, 5, 30936-30942.
Stolz, B.; Mönkemeyer, F.; Mader, M.; Schmidt, S.; Volk, L.; Steinberg, T.; Bruchmann, B.; Mülhaupt, R. Macromol Chem Phys 2020, 221, 2000132.
Veith, G. M.; Doucet, M.; Sacci, R. L.; Vacaliuc, B.; Baldwin, J. K.; Browning, J. F. Sci Rep 2017, 7, 6326.
Nguyen, C. C.; Lucht, B. L. J Electrochem Soc 2014, 161, A1933.
Dalavi, S.; Guduru, P.; Lucht, B. L. J Electrochem Soc 2012, 159, A642.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
an anode comprising silicon;
an electrolyte comprising:
a solvent;
a lithium salt; and
a heterocyclic compound of formula: 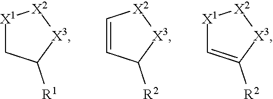
or a mixture of any two or more thereof,
wherein:
each X¹ independently is C or O;
each X² independently is C═O or S(═O)₂;
each X³ independently is C or O;
each R¹ independently is linear alkenyl, linear alkenylalkyl, or linear acrylate;
each R² independently is H, linear alkyl, linear alkenyl, linear alkenylalkyl, or linear acrylate;
the heterocyclic compound is present in the electrolyte at a concentration of about 11 wt. % to about 80 wt. % based on the weight of the electrolyte;
X² is S(═O)₂ or at least one of X¹ or X³ is O; and
the electrolyte is free of saturated cyclic carbonates.

2. The electrochemical cell of claim 1, wherein X¹ is O, X² is C═O, and X³ is O.

3. The electrochemical cell of claim 1, wherein X² is S(═O)₂.

4. The electrochemical cell of claim 1, wherein the heterocyclic compound is: 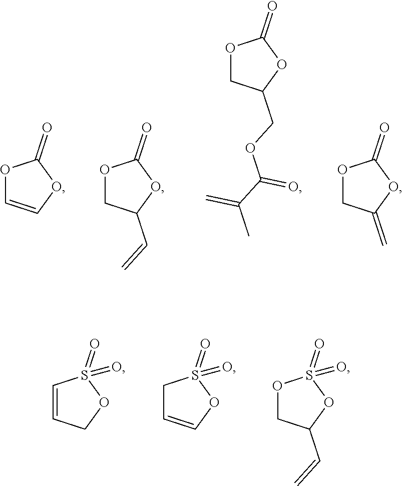
or a mixture of any two or more thereof.

5. The electrochemical cell of claim 1, wherein the heterocyclic compound is vinylene carbonate.

6. The electrochemical cell of claim 1, wherein the electrolyte is free of fluoroethylene carbonate, difluoroethylene carbonate, and fluorinated propylene carbonate.

7. The electrochemical cell of claim 1, wherein the saturated cyclic carbonates comprise ethylene carbonate and propylene carbonate.

8. The electrochemical cell of claim 1, wherein the heterocyclic compound is present in the electrolyte from about 11 wt. % to about 20 wt. %.

9. The electrochemical cell of claim 1, wherein the heterocyclic compound is present in the electrolyte from about 30 wt. % to about 80 wt. %.

10. The electrochemical cell of claim 1, wherein the solvent comprises a linear carbonate.

11. The electrochemical cell of claim 10, wherein the linear carbonate comprises ethyl methyl carbonate, dimethyl carbonate, diethyl carbonate, or a mixture of any two or more thereof.

12. The electrochemical cell of claim 1, wherein the solvent comprises 1,2-dimethoxyethane, 1,3-dioxolane, a fluorinated ether, a sulfone, or a mixture of any two or more thereof.

13. The electrochemical cell of claim 1, wherein the anode comprises the silicon in a concentration of about 50 wt. % to about 90 wt. %.

14. The electrochemical cell of claim 1 further comprising a solid electrolyte interface (SEI) comprising a hydroxylated polymer.

15. The electrochemical cell of claim 1 further comprising a cathode comprising a layered lithium nickel cobalt manganese oxide, layered lithium nickel cobalt aluminum oxide, spinel lithium nickel manganese oxide, lithium iron phosphates, lithium cobalt phosphates, lithium manganese phosphates, lithium cobalt oxide, lithium nickel oxide, lithium manganese oxide, or a mixture of any two of more thereof.

16. The electrochemical cell of claim 1, wherein the lithium salt comprises LiClO₄, LiPF₆, LiAsF₆, LiBF₄, LiB(C₂O₄)₂ (“LiBOB”), LiBF₂(C₂O₄) (“LiODFB”), LiCF₃SO₃, LiN(SO₂F)₂ (“LiFSI”), LiPF₃(C₂F₅)₃ (“LiFAP”), LiPF₄(CF₃)₂, LiPF₃(CF₃)₃, LiN(SO₂CF₃), LiCF₃CO₂, LiC₂F₅CO₂, LiPF₂(C₂O₄)₂, LiPF₄C₂O₄, LiN(CF₃SO₂)₂, LiC(CF₃SO₂)₃, LiN(SO₂C₂F₅)₂, a lithium alkyl fluorophosphate, Li₂B₁₂X_{12-α}H_{α}, Li₂B₁₀X_{10-β}H_{β}, or a mixture of any two or more thereof, wherein X is OH, F, Cl, or Br; α is 0, 1, 2, 3, 4, 5, 6, 7, 8, 9, 10, 11, or 12; and β is 0, 1, 2, 3, 4, 5, 6, 7, 8, 9, or 10.

17. An electrochemical cell comprising:
an anode comprising silicon; and
an electrolyte comprising a linear carbonate and vinylene carbonate in a concentration of about 11 wt. % to about 80 wt. %, wherein the electrochemical cell is free of ethylene carbonate.

18. The electrochemical cell of claim 17, wherein the electrolyte comprises the vinylene carbonate in an amount from about 15 wt. % to about 20 wt. %.

19. A method of screening stability of an electrolyte component for lithium-silicon batteries, the method comprising:
contacting the electrolyte component with trimethylsilyllithium; and
identifying products of reactions between the electrolyte component and the trimethylsilyllithium.
